(19) United States
(12) Patent Application Publication
(10) Pub. No.: US 2022/0009421 A1
(43) Pub. Date: Jan. 13, 2022

(54) MOTORIZED RAIL TRANSPORT SYSTEM AND TRANSPORTABLE STORAGE CONTAINER FOR A VEHICLE

(71) Applicant: Richard K. Mannone, Ocala, FL (US)

(72) Inventor: Richard K. Mannone, Ocala, FL (US)

(21) Appl. No.: 16/924,715

(22) Filed: Jul. 9, 2020

(51) Int. Cl. B60R 9/06; B60R 11/06

(52) U.S. Cl. CPC B60R 9/065; B60R 2011/0036; B60R 11/06

(57) ABSTRACT

The present disclosure is directed to a motorized cargo moving system for moving storage units from the front of a truck bed to the rear and back again. The disclosed product is made of two components, a motorized rail system and a customizable storage unit. In a pickup truck embodiment, the rail system sits on top of vertical rails disposed on or in a pickup truck bed and may run to the tailgate. A storage unit sits on the rails or tracks and is moved by a transport system

### BACKGROUND OF THE DISCLOSURE

### Field of the Invention

This disclosure generally relates to storage containers for vehicles and more particularly to (onboard) movable and motorized storage containers for trucks.

### Description of the Related Art

Currently, commercial and passenger pickup truck owners do not have the ability to access items stored in cargo units of a truck without having to climb into the bed of the truck. Also, for large commercial vehicles there is no way to easily move cargo in and out without (the use of a forklift, pallet jack, or) physically climbing into the the truck as well. Accordingly, the ability to fully utilize a pickup truck's storage capability is limited. Furthermore, there is a significant chance of injury when an individual climbs in and out of the bed of a truck.

There is also need for users with existing storage units to retrofit their vehicles and enjoy the ability of moving their cargo from the front towards the rear of the vehicle and back again (intermittently) using a motorized (rail) system without having to climb into the vehicle. For large commercial vehicles, there is also a need for moving and transporting cargo efficiently and with less damage.

### SUMMARY OF THE INVENTION

The present disclosure is directed to a motorized cargo moving system for moving storage units (intermittently) from the front of a truck bed to the rear and back again. The disclosed product is made of two components, a motorized rail system and a customizable storage unit. In a pickup truck embodiment, the rail system sits on top of vertical rails disposed on or in a pickup truck bed and may run to the tailgate. A storage unit sits on the rails or tracks and is moved by a transport system.

Other features and aspects will be apparent from the following detailed description, the drawings, and the claims.

### BRIEF DESCRIPTION OF THE DRAWINGS

FIG. 1 shows an embodiment of a pickup truck track system of the disclosure.

FIG. 2 shows a rail with brackets of the disclosure.

FIG. 3A shows another view of a rail and bracket of the disclosure.

FIG. 3B shows a blow up of an embodiment of a worm screw of the disclosure.

FIG. 3C shows another blow up of an embodiment of a worm screw of the disclosure.

FIG. 4 shows an edge on view of another embodiment of the disclosure.

FIG. 5 shows another view of an embodiment of the disclosure.

FIG. 6 shows another embodiment of the disclosure.

FIG. 7A shows another embodiment of a storage unit and rail system of the disclosure.

FIG. 7B shows an embodiment of control buttons of the disclosure.

FIG. 7C shows an embodiment of a motor box of the disclosure.

FIG. 8A shows another embodiment of a storage unit and rail system of the disclosure.

FIG. 8B shows a blow up of an embodiment of a rail system of the disclosure.

FIG. 8C shows another blow up of an embodiment of a rail system of the disclosure.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, products, and/or systems, described herein. However, various changes, modifications, and equivalents of the methods, products, and/or systems described herein will be apparent to an ordinary skilled artisan.

In embodiments, the present disclosure relates to a motorized cargo moving system designed to move storage units from the front of the bed of a truck to a position interior and/or all the way to the rear and back again. The disclosed product may include two basic components: a motorized rail system and a customizable storage unit. The rail system sits on top of vertical rails disposed in or on a truck bed and run interior to the bed and all the way to the tailgate. The storage unit is disposed on the tracks and may be transported by an onboard transport system.

In embodiments, transport controls allow a user to control movement of a storage unit disposed on the rails. For example, a user may press a FORWARD button to have the unit move to the rear of the bed and a BACK button to return to the front. In one example, a user may continue to depress a button in either position until the cargo unit reaches a desired position. Otherwise the unit will stop where the button is released.

A rail system may also be provided independent of a storage unit. The rail system may include modification plates to adapt a variety of storage units to the rail system. The motor of the rail system may move both sides of the tracks simultaneously and may be capable of moving cargo in the range of 0 to about 500 lbs.

The present disclosure provides rails which attach to the vertical sides or side panels of a bed or cargo area for large commercial vehicles including trucks or pickup trucks. The disclosure provides an independent, self-powered motor to move storage units. The disclosure also provides a fully customizable storage unit.

The present disclosure also provides a rail system independent of a storage unit. The rail system may be provided on vertical rails of a pickup truck bed and may include adapter plates for use with a variety of storage units. The present disclosure also provides a rail system including a customizable storage unit included on the vertical rails. The rails may be installed horizontally in the cargo section of large commercial vehicles in single or stacked configurations

Generally speaking, the motor may be situated in any convenient out-of-the-way location. In embodiments, the rail system may be disposed on top of a side rail of the vehicle and the motor suspended under a side rail towards the back of the truck bed.

An activation switch may be included as well. The activation switch may be provided in any convenient location. In one example, the activation switch may be located near the back of the truck bed under a rail. The rails may include a worm screw or drive for moving a storage unit. Brackets may be included on the rails that include a separate piece or modification plates that can be mounted to allow retrofitting of a storage container. Built-in melting clamps may be located along the rail system, like load style to prevent theft and to prevent vibrations from loosening the rails.

The rail system may be driven by a transport mechanism which can transport a storage unit from one end of a truck bed to an interior area and/or all the way to the other end. The transport mechanism may include a gear mechanism. In embodiments, the transport mechanism may include a worm screw or the like which may smoothly transport a storage container along the rails. In embodiments, relevant sections of the mounting brackets may be polymer coated including Teflon coated to promote smooth sliding of a storage container along the rails.

Motor driven worm screws may be attached to the rail system by mounting clamps. Threaded gear type edges extend to engage a worm screw and to allow a bracket to move along the worm screw when the worm screw is activated. The mounting bracket can be up to 20 inches long making it adaptable to all boxes. A polymeric or plastic material may be disposed along appropriate regions including an edge of a bracket to allow smooth gliding of the bracket along the worm screw.

In one example, on a 66-inch rail, the rail system may have a mounting clamp approximately every 24 inches along with one at each end. That is, a mounting clamp at each end, and spaced 24 inches thereafter. In general, mounting brackets can be built into the rail system wherever needed. Typically, one mounting bracket will be at each end, and the brackets will be spaced no more than about 24 inches apart.

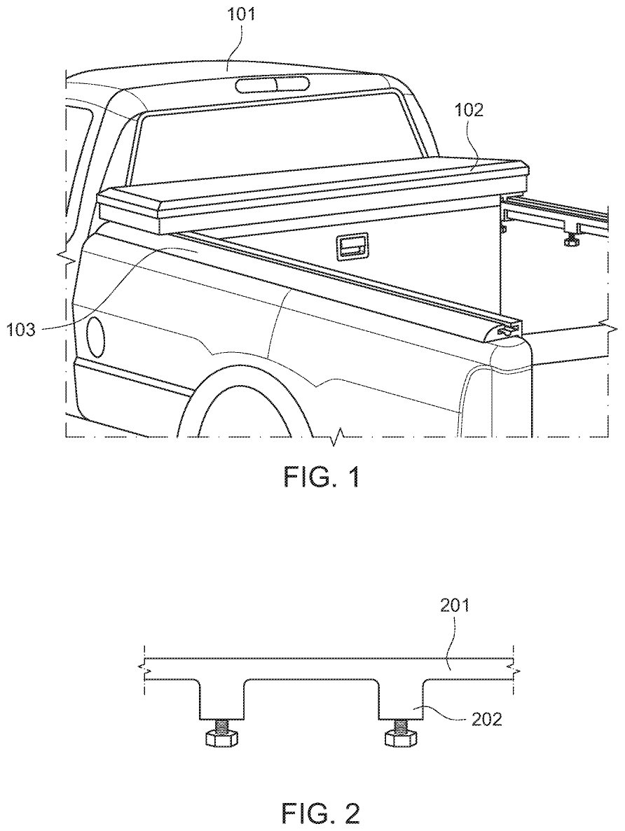

FIG. 1 shows a pickup truck 101 with storage unit 102 and rail system 103.

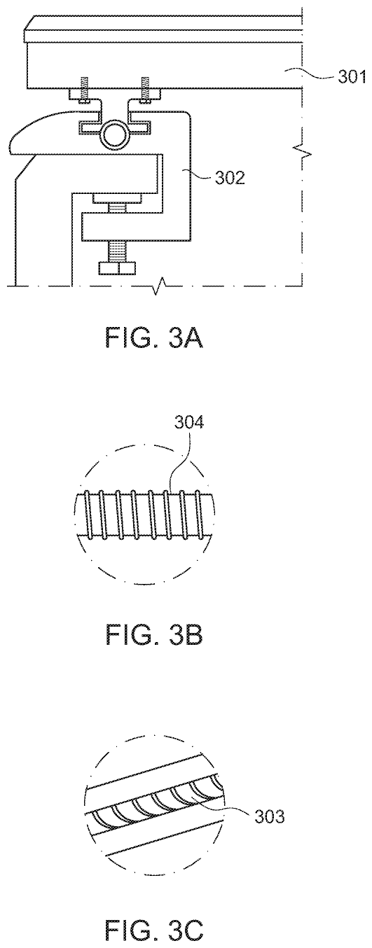

FIG. 2 shows rail 201 with brackets 202.

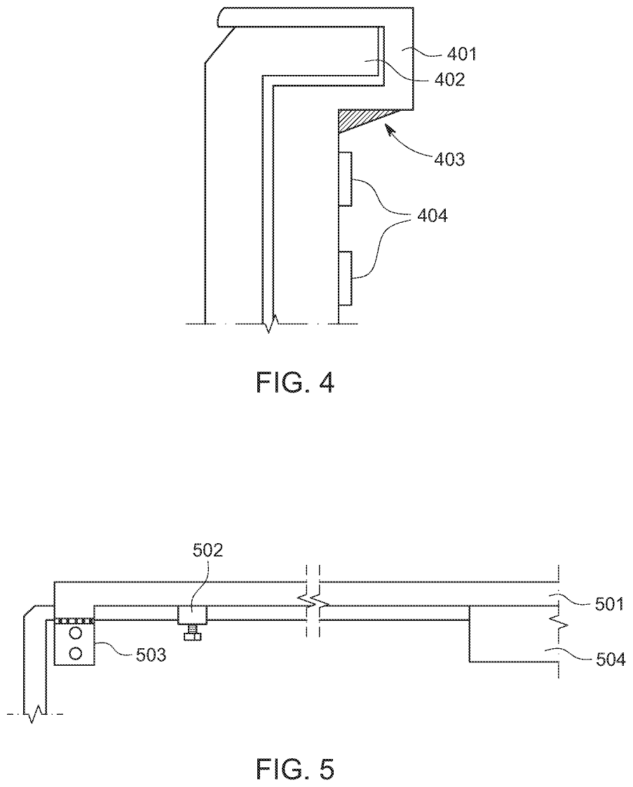

FIG. 3A shows rail 301 and bracket 302.

FIG. 3B shows a blow up of worm screw 304.

FIG. 3C shows threaded gear mechanism 303.

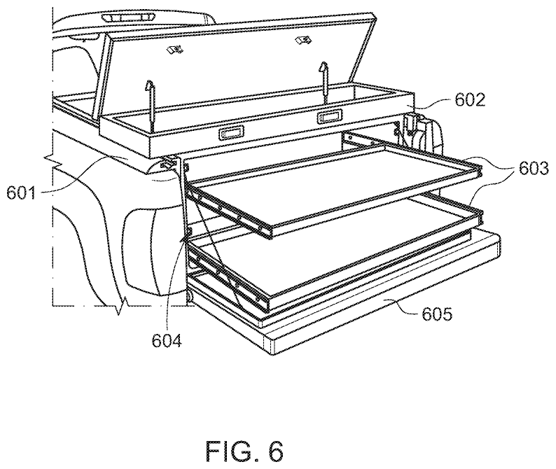

FIG. 4 shows an edge on view of rail 401 with support ribs 403 and button controls 404.

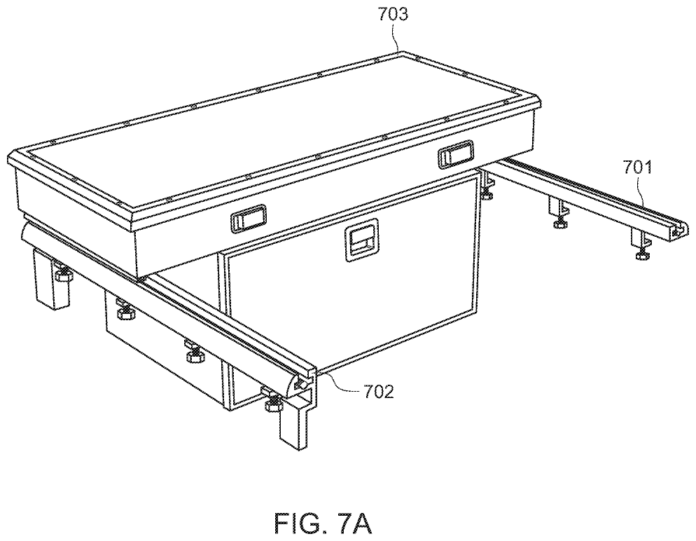

FIG. 5 shows a side view of rail 501 with bracket 502 on off activation switches 503 and motor 504.

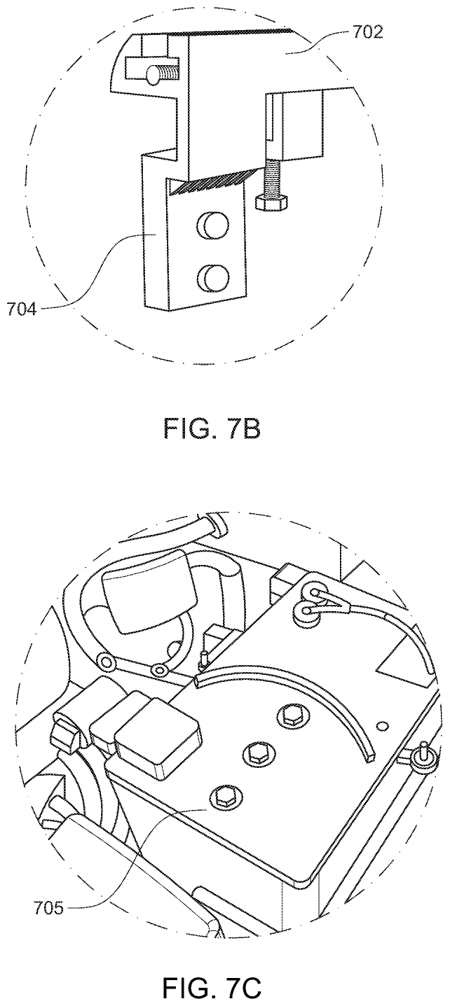

FIG. 6 shows pickup truck 600 with rails 601, storage unit 602 with two shelves 603 rings for cargo net 604 and truck tailgate 605. As one example, the storage unit may be approximately 23 inches high and 30 inches deep and shelves 603 may be slidable shelves.

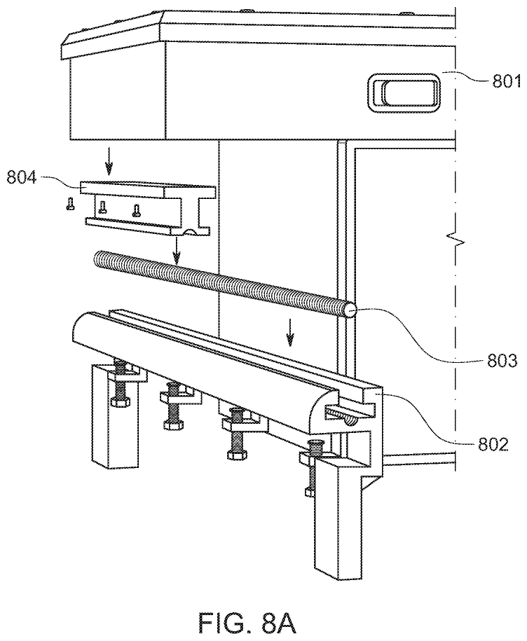

FIG. 7A shows another embodiment of a storage unit 703 and rail system 701, 702 of the disclosure.

FIG. 7B shows an embodiment of control buttons 704 attached to rail 702.

FIG. 7C shows an embodiment of a motor box 705 of the disclosure.

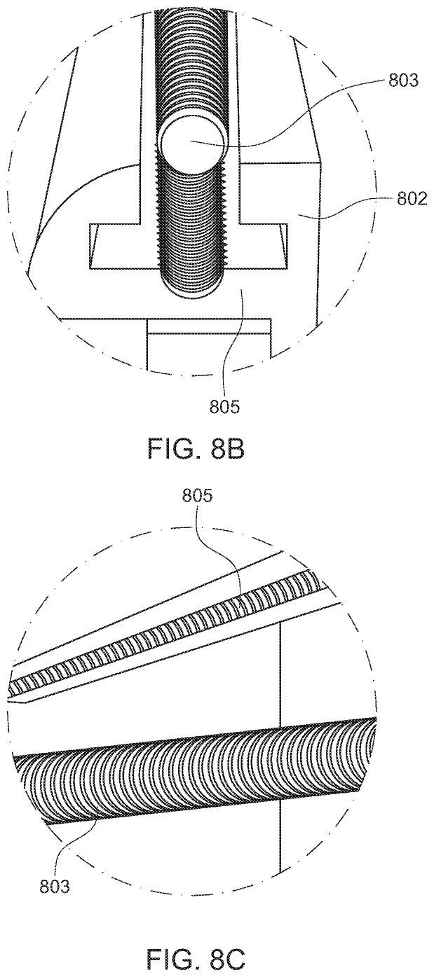

FIG. 8A shows another embodiment of a storage unit 801 and rail system 802 with worm screw 803 and bracket 804 for attaching the storage unit 801 to the rail system 802.

FIG. 8B shows a blow up of an embodiment of a rail system 802 with worm screw 803 and threaded gear 805.

FIG. 8C shows another blow up of worm screw 803 and threaded gear 805 of the disclosure.

While this disclosure includes specific examples, it will be apparent after an understanding of the disclosure of this application has been attained that various changes in form and details may be made in these examples without departing from the spirit and scope of the claims and their equivalents.

1. A motorized cargo moving system for a vehicle comprising:
a motorized rail transport system comprising one or more rails and a motor;
a storage unit attached to, and transportable by, the motorized rail transport system; and
brackets attachable to the rail transport system comprising modification plates that are configured to retrofit an existing storage container.

2. The motorized cargo moving system for a vehicle of claim 1,
wherein the motorized rail transport system comprises a gear mechanism.

3. The motorized cargo moving system for a vehicle of claim 2, wherein the gear mechanism comprises a worm screw.

4. The motorized cargo moving system for a vehicle of claim 1, wherein the motorized rail transport system transports a storage unit from one end of a vehicle bed to the other.

5. A motorized cargo moving system for a vehicle of claim 1, wherein the motorized rail transport system comprises two rails attached to the bed of a truck.

6. A motorized cargo moving system for a vehicle of claim 5, wherein the rails comprise a gear mechanism.

7. A motorized cargo moving system for a vehicle of claim 6, wherein the gear mechanism comprises a worm screw.

8. (canceled)

9. A motorized cargo moving system for a vehicle of claim 1, wherein the brackets include an organic polymer coating to facilitate transport of the storage unit.

10. A motorized cargo moving system for a vehicle of claim 9, wherein the rails are attached to a pickup truck bed side panels.

11. A motorized cargo moving system for a vehicle of claim 9, wherein the organic polymer is Teflon.

12. A motorized cargo moving system for a vehicle of claim 1, wherein the mounting bracket is approximately 20 inches long.

13. A motorized cargo moving system for a vehicle of claim 1, wherein the vehicle is a pickup truck.
